(19) United States
(12) Patent Application Publication
(10) Pub. No.: US 2012/0209566 A1
(43) Pub. Date: Aug. 16, 2012

(54) Method for Checking Plausability of Digital Measurement Signals

(75) Inventor: Marco Enrique Idiart, Stuttgart (DE)

(73) Assignee: Siemens Aktiengesellschaft, Muenchen (DE)

(21) Appl. No.: 13/383,904

(22) PCT Filed: Jul. 5, 2010
(86) PCT No.: PCT/EP2010/059535

§ 371 Date: Apr. 26, 2012

(30) Foreign Application Priority Data
Jul. 13, 2009 (DE) 10 2009 032 845.9

(51) Int. Cl. G06F 17/18

(52) U.S. Cl. 702/179

(57) ABSTRACT

A method for checking plausibility of digital measurement signals, wherein the method comprises forming a trend function for a prescribed number of successive measurement values of the measurement signal, determining the differential values between the measurement values and the trend function if the leading digit of at least one differential value is equal to zero, multiplying all differential values by a factor so that the leading digits of all differential values are non-zero values, determining a deviation between the frequency distribution of the leading digits of the differential values and the frequency distribution in accordance with Benford's law, and generating a warning message if the deviation exceeds a threshold value.

### CROSS-REFERENCE TO RELATED APPLICATIONS

This is a U.S. national stage of application No. PCT/EP2010/059535 filed 5 Jul. 2010. Priority is claimed on German Application No. 10 2009 032 845.9 filed 13 Jul. 2009, the content of which is incorporated herein by reference in its entirety.

### BACKGROUND OF THE INVENTION

1. Field of the Invention

The invention relates to fault detection and, more particularly, to a method for checking the plausibility of digital measurement signals in technical systems.

2. Description of the Related Art

Monitoring and diagnostic functions are being increasingly integrated in technical systems to detect faults or dubious states that themselves do not yet constitute a fault but may develop into such a fault. A fault message is generated in the first-mentioned case, and a warning message is generated in the second-mentioned case. The warning message may be output immediately or may be associated with other criteria that must be satisfied before the warning message is output. Technical systems are those systems in metrology, control and regulating technology, for example, process automation systems, in which sensors or measuring transducers record analog physical or chemical variables that are converted into digital measurement signals and processed further.

In order to check the plausibility of the measurement signals, their temporal profile or frequency spectrum can be analyzed, for example, and compared with an expected profile or frequency spectrum. The effort associated with this, for example, Fourier analysis, may be considerable. In contrast, the practice of monitoring the measured values obtained to determine whether maximum or minimum limit values are exceeded or undershot is very simple to implement but provides only rough information for checking the plausibility of measurement signals. In all of the cases mentioned, knowledge of the expected fault-free measurement signal profile, the frequency spectrum or the measured value range is necessary.

### SUMMARY OF THE INVENTION

It is therefore an object of the invention to provide a method by which it is easy to check the plausibility of digital measurement signals in technical systems without special knowledge of the properties of the measurement signals.

This and other objects and advantages are achieved in accordance with the invention by a method for checking the plausibility of digital measurement signals in technical systems in which a trend function is formed for a predefined number of successive measured values of the measurement signal (S), the differential values between the measured values and the trend function are determined. If the leading digit of at least one differential value is equal to zero, then all differential values are multiplied by a factor, with the result that the leading digits of all differential values are not equal to zero, a difference between the frequency distribution of the k (k≧1) leading digits of the differential values and the frequency distribution in accordance with Benford's law is determined, and a warning message is generated if the difference exceeds a limit value.

In an alternative embodiment, instead of scaling (multiplying) the differential values, it is possible to determine the most significant digit position at which the digits of all differential values are not equal to zero. Here, the frequency distribution of the k (k≧1) leading digits of the differential values is determined from the determined most significant digit position and is compared with the Benford distribution.

As representative of the many publications relating to Benford's law, reference is made to the explanations in Wikipedia, found on the Internet on Jul. 3, 2009 at: http://de.wikipedia.org/wiki/Benfordsches_Gesetz.

Known uses of Benford's law are found in finance, business management and the insurance industry for checking the plausibility of data records to check accounting data of a company for correctness as part of the audit, for example.

The invention is based on the surprising insight that digital measurement signals in technical systems can also be checked for plausibility using Benford's law. The prerequisite is for the data being examined to obey the Benford distribution. The measured values to be examined therefore must not be preprocessed by rounding, formatting, measured value limitation or another manner that changes the statistical distribution of their digits. Therefore, the digital raw measured values obtained immediately after digitizing the analog raw measurement signal are preferably used. It is also important for the resolution of the measured values, i.e., the number of digit positions, to be sufficiently high.

The measured values are usually in a particular value range (for example, measured temperature values in the range of 15° C. to 25° C.). As a result, the measured values themselves are not examined, but rather their differences (differential values) from a trend function. In the simplest case, i.e., in the case of stationary measurement signals, the arithmetic mean value of the predefined number of successive measured values can be used as the trend function. In the case of dynamic measurement signals, the number of measured values used to form the mean value is reduced or sliding averaging is performed. Further possibilities for adjusting the trend of the measured values are to form differences between successive measured values, to approximate the sequence of measured values by means of polynomials and to subtract them from the measured values.

Using scale invariance as the prerequisite for a Benford distribution, the differential values, for example, are scaled such that the leading digits of all differential values are not equal to zero. Benford analysis is then possible.

In order to continuously monitor the measurement signal, the plausibility check is repeated after every Nth (N≧1) measured value with the addition of the N new measured values and with the omission of the respective N oldest measured values.

During examinations on real measurement signals, it has emerged that, in many cases, the Benford analysis can be restricted to the most significant digit, i.e., k=1, and also to a few lowest numerical values or even the lowest numerical value when the base of the number system is sufficiently large. For example, when representing the digital measured values in the decimal system (base 10), only the frequency of the leading digit with the value “1” can be compared with the corresponding Benford frequency, with the result that only a single comparison operation is required for a measurement series.

In addition to the leading digits, the last digits may also provide further information relating to the correctness/plausibility of the measurement signal. For example, hardware defects that reduce the resolution of the digital measured values may thus be detected. For this reason, the plausibility check is preferably also extended to the k′ (k′≧1) last digits of the measured values or differential values.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In order to explain the invention further, reference is made below to the drawings in which:

FIG. 1 shows an example of a measuring transducer having a device for checking the plausibility of a recorded and digitized measurement signal;

FIG. 2 shows a flowchart of the method for checking the plausibility of digital measurement signals in accordance with an embodiment of the invention; and

FIG. 3 shows an example of the determination of the difference between the frequency distribution of the leading digits, which results from the measurement, and the frequency distribution in accordance with Benford's law.

### DETAILED DESCRIPTION OF THE PREFERRED EMBODIMENTS

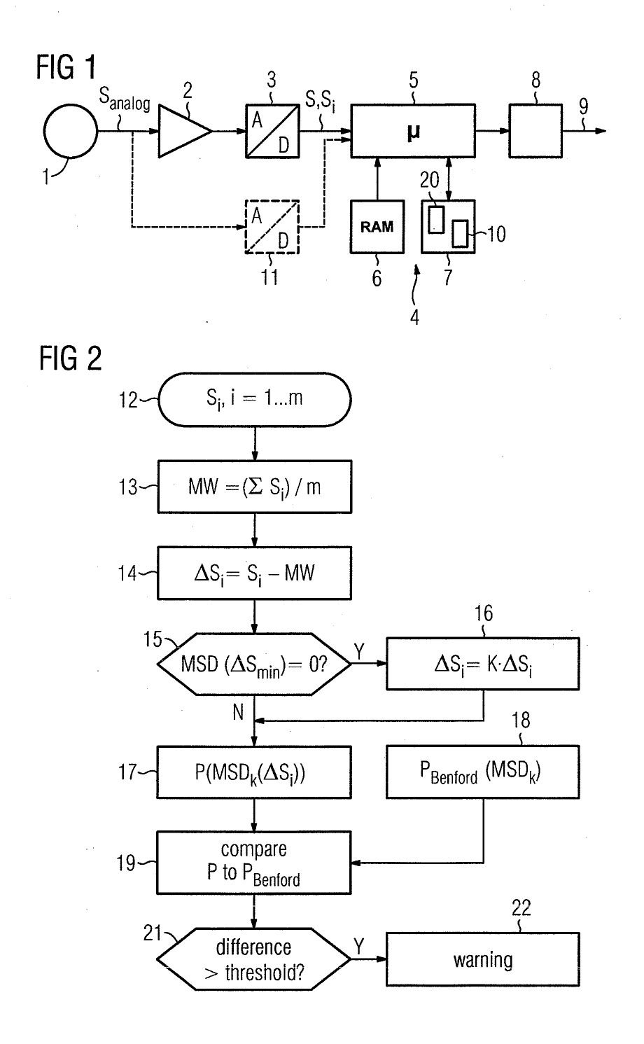

FIG. 1 shows, in a manner illustrated in simplified form as a block diagram, a measuring transducer having a sensor 1, for example, a pressure sensor, which provides an analog measurement signal (raw signal) S_{analog}. The analog measurement signal S_{analog} is initially preamplified in an analog measurement signal amplifier 2 and is possibly filtered before it is converted into a digital measurement signal S with measured values Sᵢ by an analog/digital converter 3. In a digital signal processing device 4 consisting of a microprocessor (CPU) 5, a main memory (RAM) 6 and a program memory (ROM) 7, the digital measurement signal S is amplified, equalized, filtered, standardized and changed into an output signal (measuring transducer signal) 9 that is suitable for display or for transmission via a communication interface 8.

In addition to the signal processing algorithm, an algorithm 10 for checking the plausibility of the digital measurement signal S using Benford's law is also implemented in the microprocessor 5 or the program memory 7.

If the preamplification of the analog measurement signal S_{analog} is not performed in a linear manner in the measurement signal amplifier 2 and/or if analog filtering occurs, the analog measurement signal S_{analog} is digitized in a separate analog/digital converter 11 and is supplied to the signal processing device 4 for the plausibility check.

FIG. 2 shows individual steps (blocks 12 to 21) of the plausibility check of the digital measurement signal S in a flowchart.

The digital measured values Sᵢ are represented in a number system with the base b and n available digit positions, with the result that the following applies:

Sᵢ=s_{n,i}·bⁿ+s_{n-1,i}·bⁿ⁻¹+ . . . +s_{0,i}·b⁰,

where s_{n,i}, s_{n-1,i}, . . . , s_{0,i} denote the individual digits between 0 and b−1.

In order to check the plausibility of the digitized measurement signal S, the mean value MW of m successive measured values Sᵢ is initially formed after every Nth measured value Sᵢ (blocks 12 and 13):

$$M W = \frac{1}{m} \cdot {\sum }_{i = 1}^{m} {S}_{i} .$$

In a next step, the differences ΔSᵢ between the m individual measured values Sᵢ and the mean value MW are calculated (block 14):

ΔSᵢ=Sᵢ−MW.

If the leading digit (MSD=most significant digit) z_{n,i} of one or more differential values ΔSᵢ is equal to zero, all m differential values ΔSᵢ are multiplied by a constant factor K which is selected such that the respectively leading digit z_{n,i} of all m differential values ΔSᵢ is not equal to zero (blocks 15, 16). If, for example, the smallest of all measured values sₘᵢₙ has two leading zeros, i.e.,

Δs_{n,min}=ΔS_{n-1,min}=0, ΔS_{n-2, min}≠0, the factor K=b² can be selected.

The frequencies P(Δsₙ, . . . , Δsₙ₋₍ₖ₋₁₎) of the k (k≧1) leading digits Δsₙ, . . . , Δsₙ₋₍ₖ₋₁₎ of the m differential values ΔSᵢ, which are possibly multiplied by the factor K, are now compared with the Benford frequency distribution P_{Benford}(dₙ, . . . , dₙ₋₍ₖ₋₁₎) for the k leading digits of a number (blocks 17, 18, 19, where MSDₖ denotes the k leading digits):

$${P}_{Benford} ( {d}_{n} , … , {d}_{n - ( k - 1 )} ) = {log}_{b} ( 1 + \frac{1}{{\sum }_{j = 1}^{k} {d}_{n - ( j - 1 )} {b}^{n - ( j - 1 )}} ) ,$$

where d=1, 2, . . . , b−1.

If only the first leading digit Δsₙ is taken into account, which is sufficient in most cases, particularly with a relatively large base b, the Benford distribution is simplified as follows:

$${P}_{Benford} ( {d}_{n} ) = {log}_{b} ( 1 + \frac{1}{{d}_{n}} ) .$$

For example, the following frequency distribution of the leading digit of numbers results for the base b=10 according to Benford's law:

| dₙ | 1 | 2 | 3 | 4 | 5 | 6 | 7 | 8 | 9 |
|---|---|---|---|---|---|---|---|---|---|
| P_{Benford} | 0.301 | 0.176 | 0.125 | 0.097 | 0.079 | 0.067 | 0.058 | 0.051 | 0.046 |

The Benford distribution P_{Benford}(dₙ, . . . , dₙ₋₍ₖ₋₁₎) is stored in one of memories 6, 7, for example, as a table 20.

Finally, the difference between the frequency distribution P(MSDₖ(ΔSᵢ)) of the k leading digits MSDₖ of the m differential values ΔSᵢ and the Benford frequency distribution P_{Benford}(MSDₖ) is determined and a warning message is generated if the difference exceeds a limit value (blocks 21, 22).

The warning message may be output immediately or may be associated with other monitoring criteria that must be satisfied before the warning message is output.

The difference between the frequency distributions can be determined, for example, using the standard error or the chi-square test, which, however, can take up too much computation power in the case of relatively small microprocessors 5.

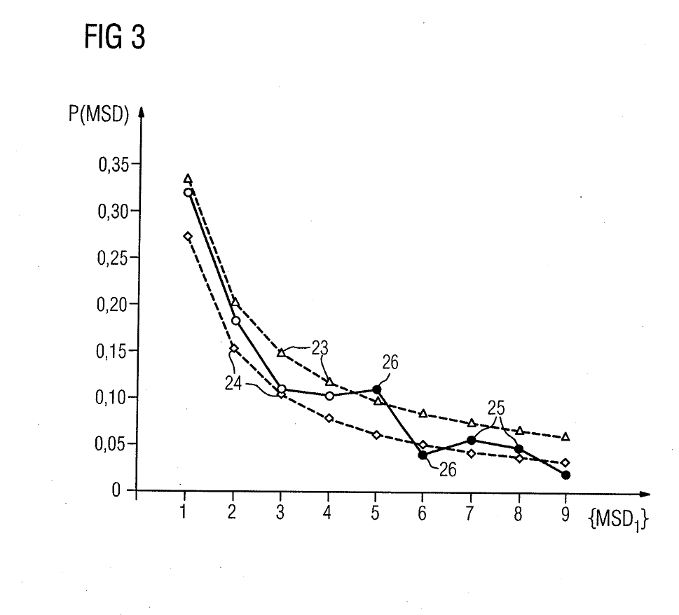

FIG. 3 shows an example which is associated with minimal computation complexity and in which a corridor having an upper limit 23 and a lower limit 24 is defined, which limits run above and below the Benford frequency distribution. In the example shown, the leading digit MSD₁ of the differential values ΔSᵢ with values between 1 and 9 is considered. Assuming that, in the case of a measurement signal S without interference, the determined frequencies of the leading digit of the differential values ΔSᵢ are subject to a normal distribution (Gaussian distribution) with the Benford distribution as the mean value, the limits 23, 24 can be defined, for example, as twice the standard deviation from the Benford distribution, with the result that, in the fault-free case, approximately 95% of the frequency distributions 25 of the leading digit which result from the measurement are within the corridor in theory. In contrast, determined frequency distributions 26 outside the corridor indicate a fault and result in the generation of the warning message. The corridor with the limits 23 and 24 is determined in advance and is stored in the program memory 7 as part of the algorithm 10.

The lower numerical values occur with a greater probability than the higher numerical values. As a result, the corridor is narrower in percentage terms in the region of the lower numerical values. For this reason, it will suffice, in many cases, to restrict the Benford analysis to a few numerical values, i.e., the lowest numerical values, for example, “1” and “2”, or even to the lowest numerical value “1”. In the latter case, only a single comparison operation is then required.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those method steps which perform substantially the same function in substantially the same way to achieve the same results are within the scope of the invention. Moreover, it should be recognized method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-5. (canceled)

6. A method for checking plausibility of digital measurement signals in technical systems, comprising:
forming, in a microprocessor, a trend function for a predefined number of successive measured values of the measurement signal;
determining, by the microprocessor, differential values between the successive measured values and the trend function;
multiplying, by the microprocessor, all the differential values by a factor such that leading digits of all the differential values are not equal to zero, if a leading digit of at least one differential value is equal to zero;
determining, by the microprocessor, a difference between a frequency distribution of leading digits of the all differential values and a frequency distribution in accordance with Benford's law; and
generating a warning message if the difference exceeds a limit value.

7. The method as claimed in claim 6, wherein the plausibility check is repeated after every fixed number N of measured values of the measurement signal with an addition of N new measured values and with an omission of a respective number of oldest measured values.

8. The method as claimed in claim 6, wherein the plausibility check is restricted to a leading digit one of having a plurality of lowest numerical values and having a lowest numerical value of “1”.

9. The method as claimed in claim 6, wherein the plausibility check is extended to one of last digits of the measured values and differential values.

10. A method for checking plausibility of digital measurement signals in technical systems, comprising:
forming, in a microprocessor, a trend function for a predefined number of successive measured values of a measurement signal;
determining, by the microprocessor, differential values between the measured values and a trend function;
determining, by the microprocessor, a most significant digit position at which digits of all the differential values are not equal to zero;
determining, by the microprocessor, a difference between a frequency distribution of leading digits of all the differential values from the determined most significant digit position and a frequency distribution in accordance with Benford's law; and
generating a warning message if the difference exceeds a limit value.

11. The method as claimed in claim 10, wherein the plausibility check is repeated after every fixed number N of measured values of the measurement signal with an addition of N new measured values and with an omission of a respective number of oldest measured values.

12. The method as claimed in claim 10, wherein the plausibility check is restricted to a leading digit one of having a plurality of lowest numerical values and having a lowest numerical value of “1”.

13. The method as claimed in claim 10, wherein the plausibility check is extended to one of last digits of the measured values and differential values.
